(19) United States
(12) Patent Application Publication
(10) Pub. No.: US 2026/0050641 A1
(43) Pub. Date: Feb. 19, 2026

(54) CONTENT RECOMMENDATION

(71) Applicants: Beijing Youzhuju Network Technology Co., Ltd., Beijing (CN); Lemon Inc., Grand Cayman (KY)

(72) Inventors: Junyi Chen, Beijing (CN); Lu Chi, Beijing (CN); Zehuan Yuan, Beijing (CN); Bingyue Peng, Los Angeles, CA (US)

(21) Appl. No.: 19/261,493

(22) Filed: Jul. 7, 2025

(30) Foreign Application Priority Data
Aug. 15, 2024 (CN) 202411125696.0

(51) Int. Cl. G06F 16/9535

(52) U.S. Cl. CPC G06F 16/9535

(57) ABSTRACT

A method, an apparatus, a device, a storage medium, and a program product for content recommendation are provided. The method includes: obtaining a content item sequence associated with historical behavior data of a target user, the content item sequence including a plurality of content items for which the target user sequentially performs conversion behavior; determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; and determining, by using a second machine learning model and based on at least the plurality of content item embedding representations, a recommended content item to be recommended to the target user.

### CROSS-REFERENCE

The present application claims priority to Chinese Patent Application No. 202411125696.0, filed on Aug. 15, 2024, and entitled “METHOD, APPARATUS, DEVICE AND MEDIUM FOR CONTENT RECOMMENDATION”, which is incorporated herein by reference in its entirety.

### FIELD

Example embodiments of the present disclosure generally relate to the field of computer technology, and in particular, to content recommendation.

### BACKGROUND

A recommendation algorithm needs to understand user needs to predict future behavior across various content items. The key to effective recommendation lies in accurately modeling content items and user characteristics. Currently, mainstream recommendation methods are mainly based on identification (ID), and encode by converting content items and users into IDs and creating corresponding embedding tables, and these methods use collaborative filtering to learn content items and user characteristics. In order to capture different users' needs for content, the related art provides a method for sequential modeling. However, these methods are usually dominated by embedding parameters, the size of the model is relatively small, and they rely heavily on ID features, resulting in poor performance in cold start scenarios of content, and relatively shallow neural network is difficult to model complex and diverse content recommendation.

### SUMMARY

In a first aspect of the present disclosure, a method for content recommendation is provided. The method includes: obtaining a content item sequence associated with historical behavior data of a target user, the content item sequence comprising a plurality of content items for which the target user sequentially performs conversion behavior; determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; and determining, by using a second machine learning model and based on at least the plurality of content item embedding representations, a recommended content item to be recommended to the target user.

In a second aspect of the present disclosure, an apparatus for content recommendation is provided. The apparatus includes: a content item sequence obtaining module configured to obtain a content item sequence associated with historical behavior data of a target user, the content item sequence comprising a plurality of content items for which the target user sequentially performs conversion behavior; a content item embedding representation determining module configured to determine, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; and a recommended content item determining module configured to determine, by using a second machine learning model and based on at least the plurality of content item embedding representations, a recommended content item to be recommended to the target user.

In a third aspect of the present disclosure, an electronic device is provided. The electronic device includes at least one processor and at least one memory, where the at least one memory is coupled to the at least one processor and stores instructions for execution by the at least one processor, and the instructions, when executed by the at least one processor, cause the electronic device to perform the method according to the first aspect.

In a fourth aspect of the present disclosure, a computer-readable storage medium is provided. The computer-readable storage medium has a computer program stored thereon, where the computer program, when executed by a processor, implements the method according to the first aspect.

In a fifth aspect of the present disclosure, a computer program product is provided. The computer program product includes a computer program, and the computer program, when executed by a processor, implements the method according to the first aspect.

It should be understood that the content described in this section is not intended to limit the key features or important features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other features, advantages, and aspects of the embodiments of the present disclosure will become more apparent when taken in conjunction with the drawings and with reference to the following detailed description. In the drawings, the same or similar reference numbers refer to the same or similar elements, where:

FIG. 1 shows a schematic diagram of an example environment in which embodiments of the present disclosure can be implemented;

FIG. 2 shows a schematic diagram of an architecture of a recommendation system according to some embodiments of the present disclosure;

FIG. 3A shows a schematic diagram of an architecture of a recommendation system according to other embodiments of the present disclosure;

FIG. 3B shows a schematic diagram of an architecture of a recommendation system according to other embodiments of the present disclosure;

FIG. 4 shows a schematic diagram of applying a first machine learning model and a second machine learning model to an online recommendation model according to some embodiments of the present disclosure;

FIG. 5 shows a flowchart of a method for content recommendation according to some embodiments of the present disclosure;

FIG. 6 shows an example structure block diagram of an apparatus for content recommendation according to some embodiments of the present disclosure; and

FIG. 7 shows a block diagram of an electronic device that can implement one or more embodiments of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure can be implemented in various forms, and should not be construed as limited to the embodiments set forth herein. On the contrary, these embodiments are provided for a thorough and complete understanding of the present disclosure. It should be understood that the drawings and embodiments of the present disclosure are only for illustrative purposes, and are not intended to limit the protection scope of the present disclosure.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below.

It can be understood that the data involved in the technical solution of the present disclosure (including but not limited to the data itself, the acquisition or use of the data) should comply with the requirements of corresponding laws, regulations and related regulations.

It can be understood that, before using the technical solutions disclosed in the embodiments of the present disclosure, the user should be informed of the type, use scope, use scenario, etc. of the personal information involved in the present disclosure and obtain the authorization of the user in an appropriate manner in accordance with relevant laws and regulations.

For example, in response to receiving an active request from the user, prompt information is sent to the user to explicitly prompt the user that the operation requested by the user will require the acquisition and use of the personal information of the user, so that the user can independently select whether to provide personal information to software or hardware such as an electronic device, an application, a server, or a storage medium that performs an operation of the technical solution of the present disclosure according to the prompt information.

As an optional but non-restrictive implementation, the manner of sending prompt information to the user in response to receiving an active request from the user may be, for example, a pop-up window, and the prompt information may be presented in a text manner in the pop-up window. In addition, the pop-up window may also carry a selection control for the user to select “agree” or “disagree” to provide personal information to the electronic device.

It can be understood that the above process of notifying and obtaining user authorization is only illustrative, and does not constitute a limitation to implementations of the present disclosure, and other manners that satisfy relevant laws, regulations and rules may also be applied to the implementations of the present disclosure.

As used herein, the term “model” may learn the association relationship between the corresponding input and output from the training data, so that after the training is completed, the corresponding output may be generated for a given input. The generation of the model may be based on a machine learning technology. Deep learning is a machine learning algorithm that uses multiple layers of processing units to process inputs and provide corresponding outputs. A neural network model is an example of a model based on deep learning. In this text, “model” may also be referred to as “machine learning model”, “learning model”, “machine learning network” or “learning network”, and these terms may be used interchangeably herein.

A “neural network” is a machine learning network based on deep learning. The neural network may process an input and provide a corresponding output, and it usually includes an input layer and an output layer and one or more hidden layers between the input layer and the output layer. A neural network used in deep learning applications usually includes many hidden layers, thereby increasing the depth of the network. The individual layers of the neural network are connected in sequence, so that the output of the previous layer is provided as the input of the subsequent layer, where the input layer receives the input of the neural network, and the output of the output layer is the final output of the neural network. Each layer of the neural network includes one or more nodes (also referred to as processing nodes or neurons), and each node processes input from the previous layer.

Generally, machine learning can generally include three stages, namely, a training stage, a testing stage, and an application stage (also known as an inference stage). In the training stage, a given model may be trained by using a large amount of training data, and the parameter values are continuously iteratively updated until the model can obtain consistent inferences that meet expected goals from the training data. Through training, the model can be considered to be able to learn the association (also referred to as input-to-output mapping) from input to output from the training data. The parameter values of the trained model are determined. In the testing stage, a test input is applied to the trained model to test whether the model can provide a correct output, thereby the performance of the model is determined. The testing stage can sometimes be incorporated into the training stage. In the application or inference stage, the trained model can be used to process actual model inputs and determine corresponding model outputs based on the parameter values obtained from training.

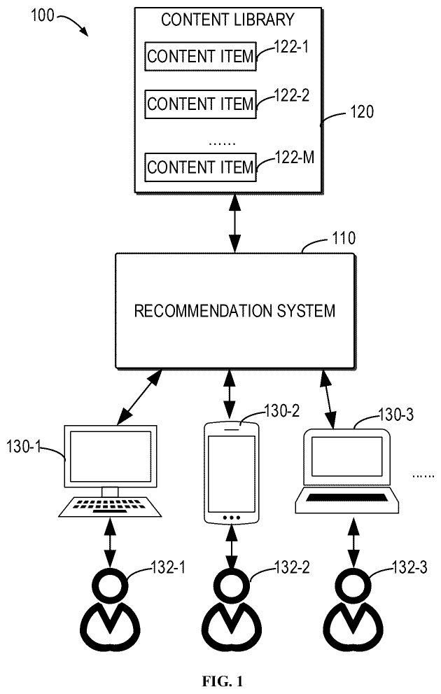

FIG. 1 shows a schematic diagram of an example environment 100 in which embodiments of the present disclosure can be implemented. In the environment 100, a recommendation system 110 is configured to provide users with one or more specific recommended content items related to one or more resources (for example, provide them to a terminal device 130) based on a corresponding strategy. A content library 120 includes one or more content items 122-1, 122-2, . . . , 122-M that can be recommended (collectively or individually referred to as the content item 122 for ease of discussion).

One or more terminal devices 130-1, 130-2, 130-3, etc. (collectively or individually referred to as the terminal device 130 for ease of discussion) are associated with the recommendation system 110. The recommendation system 110 may send corresponding content items 122 to the respective terminal devices 110 for provision to corresponding users 132-1, 132-2, 132-3, etc. (collectively or individually referred to as the user 132 for ease of discussion). As an example, the recommendation system 110 may be applied to various applications, websites, web pages, and other platforms accessible by the terminal device 130.

In this text, the content item refers to information or resources to be recommended, and examples thereof may include video content, audio content, images, animated images, text content, various types of entities or virtual objects, such as applications, physical goods, virtual goods, and so on. In this text, the audience may include one or more audience members, such as the user 132. The user may be any potential consumer of resources.

In the environment 100, the terminal device 110 may be any type of mobile terminal, stationary terminal, or portable terminal, including mobile phones, desktop computers, laptop computers, notebook computers, netbook computers, tablet computers, media computers, multimedia tablets, personal communication system (PCS) devices, personal navigation devices, personal digital assistants (PDA), audio/video players, digital cameras/camcorders, positioning devices, television receivers, radio broadcast receivers, electronic book devices, gaming devices, or any combination of the foregoing, including accessories and peripherals of these devices or any combination thereof. In some embodiments, the terminal device 110 may also support any type of user interface (such as “wearable” circuitry, etc.). The recommendation system 110 may be implemented, for example, in various types of computing systems/servers that can provide computing power, including but not limited to mainframes, edge computing nodes, computing devices in cloud environments, and so on.

It should be understood that the structure and function of the various elements in the environment 100 are described for illustrative purposes only, and are not intended to imply any limitation to the scope of the present disclosure.

As mentioned above, the ID-based recommendation method has some drawbacks. Language models (LMs) have made breakthroughs in various fields, demonstrating world knowledge and reasoning abilities. The success of language models has inspired exploration of integrating language models into recommendation systems. These explorations can be roughly divided into three methods. The first method is to use the language model to provide supplementary information for the recommendation system, such as summary of user behavior and expansion of content item information. The second method is to convert the recommendation system into a dialog-driven format compatible with the language model. The third method is to modify the language model to handle recommendation tasks, not just text input and output. This includes methods of inputting ID features into the language model, and methods of replacing current recommendation neural networks with language models, directly optimizing for goals such as click-through rates.

Despite the above exploration, the integration of language models with recommendation systems still poses significant challenges in terms of complexity and effectiveness. One problem is that inputting the user behavior history as text into the language model will result in an overly long input sequence. Therefore, compared with ID-based methods, language models require longer sequences to represent the same time span of user behavior, and the complexity of the self-attention module in the language model scales with the square of the sequence length. In addition, a plurality of forwards is required to recommend a single content item, resulting in reduced efficiency. In terms of effectiveness, the performance improvement of current language model-based methods over traditional methods is not significant, which raises doubts about whether the potential of language models has been fully exploited.

In addition, some key issues remain under-explored. First, the actual values of the weights of pre-trained language models are generally considered to be encapsulations of world knowledge and require further research. Although language models provide zero-shot and few-shot capabilities, their value for training on large-scale recommendation data is not clear. Second, there are doubts about the necessity of fine-tuning for recommendation tasks. Language models pre-trained on large-scale corpora exhibit strong world knowledge, but it remains to be seen whether further fine-tuning of recommendation tasks improves or degrades performance. Finally, the scalability of language models is a hallmark feature of proven scaling laws in other fields and needs to be verified in the context of recommendation systems. Although some studies have successfully verified the scaling laws in the recommendation field, these models have far fewer parameters than language models. Whether language models with billions of parameters exhibit good scalability in the recommendation field remains an open question.

In order to solve the above problems, in the embodiments of the present disclosure, a content recommendation solution is proposed. Specifically, a content item sequence associated with historical behavior data of a target user is obtained, where the content item sequence includes a plurality of content items for which the target user sequentially performs conversion behavior. A first machine learning model is used to determine a plurality of content item embedding representations respectively corresponding to the plurality of content items based on a first prompt element and description information of each of the plurality of content items, where the first prompt element indicates extraction of a corresponding content item embedding representation from the description information of each content item. A second machine learning model is used to determine a recommended content item to be recommended to the target user based on at least the plurality of content item embedding representations.

According to the solution of the present disclosure, the first machine learning model may output the plurality of content item embedding representations representing the plurality of content items, and then the second machine learning model may determine the recommended content item to be recommended to the target user based on the plurality of content item embedding representations. In this way, the hierarchical machine learning model is used for content recommendation, which can reduce the length of the input sequence and improve the performance of the machine learning model and the accuracy of recommendation.

The following will continue to describe some example embodiments of the present disclosure with reference to the drawings.

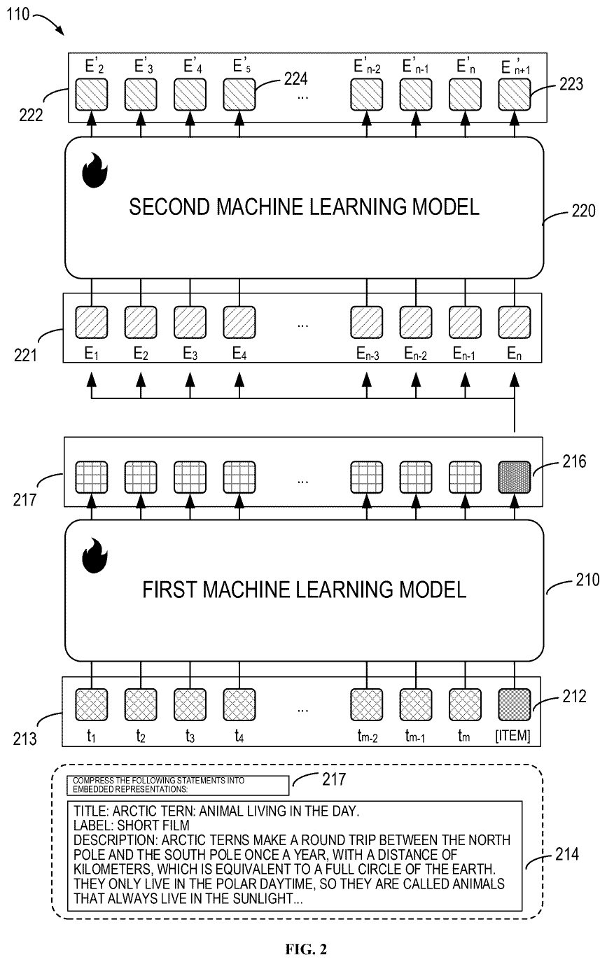

FIG. 2 shows a schematic diagram of an architecture of the recommendation system 110 according to some embodiments of the present disclosure. As shown in FIG. 2, the recommendation system 110 includes a first machine learning model 210 and a second machine learning model 220.

In some embodiments, the first machine learning model 210 and the second machine learning model 220 are language models. The recommendation system 110 may use a hierarchical language model composed of the first machine learning model 210 and the second machine learning model 220 to recommend the content item 122 to users. In this way, through the powerful text understanding ability of the language model, the embedding representation representing the content item can be accurately extracted, thereby improving the accuracy of recommendation.

In order to predict the next content item that the user is interested in, it is necessary to understand the behavior of the user. First, it is necessary to obtain a content item sequence associated with historical behavior data of a target user, where the content item sequence includes a plurality of content items for which the target user sequentially performs conversion behavior. In an example, the conversion behavior may include behaviors such as clicking, liking, favoring, and commenting, and the target is interested in the content item for which the conversion behavior has been performed.

After obtaining the content item sequence, the first machine learning model 210 is used to determine a plurality of content item embedding representations respectively corresponding to the plurality of content items based on a first prompt element 212 (represented by [ITEM]) and description information of each of the plurality of content items. The first prompt element 212 indicates extraction of a corresponding content item embedding representation 216 from description information 214 of each content item.

Description information of a content item (for example, including a title, a tag, a description, etc. of the content item) may be represented by I, and description information of a plurality of content items in chronological order may be represented by U={I₁, I₂, . . . , Iₙ}, and a target of the first machine learning model 210 and the second machine learning model 220 is to predict a next content item Iₙ₊₁. The first machine learning model 210 has powerful text understanding, induction, and summarization capabilities, and the description information of each content item may be processed using the first machine learning model 210. The input description information of the first machine learning model 210 may include a piece of text, such as a title, a description, a tag, and other information of each content item. Generally, the first machine learning model 210 is used to predict a next word element based on context. In order to enable the first machine learning model 210 to extract features of the content item, the first prompt element 212 may also be input into the first machine learning model 210, indicating that the first machine learning model 210 extracts a corresponding content item embedding from the description information of each content item. The output of the first machine learning model 210 may include the content item embedding representation 216, which is used to characterize the content item.

In some embodiments, for each of the plurality of content items, a first input sequence 213 of the first machine learning model 210 may be generated based on the first prompt element 212 and the description information 214 of the content item. A prompt 217 may be added before the description information 214, and after the description information 214 and the prompt 217 are input into a tokenizer, a plurality of word elements (m word elements) may be obtained, and the first prompt element 212 may be appended after the plurality of word elements to form the first input sequence 213. The first input sequence 213 may be represented as {t₁, t₂, . . . , tₘ, [ITEM]}, where t₁ to tₘ represent word elements corresponding to the prompt 217 and the description information 214, and [ITEM] represents the first prompt element 212. The hidden state from the last layer corresponding to [ITEM] may be regarded as the content item embedding representation 216.

After the first input sequence 213 is generated, the first input sequence 213 may be processed by using the first machine learning model 210 to obtain a first output sequence 217 of the first machine learning model 210, where the first output sequence 217 includes the content item embedding representation 216. For the first output sequence 217, a feature at a last position of the first output sequence 217 may be determined as the content item embedding representation 216 for characterizing the content item.

In some embodiments, the first prompt element 212 is placed after the description information of the content item in the first input sequence 213. In this way, placing the first prompt element at the end of the input sequence enables the machine learning model to consider the entire input sequence, thereby extracting a more accurate embedding representation.

In some embodiments, a second input sequence 221 for the second machine learning model 220 may be generated based on the plurality of content item embedding representations. The second input sequence 221 may include a plurality of content item embeddings, and the second input sequence 221 may be represented as {E₁, E₂, . . . , Eₙ}, where Eᵢ represents an embedding representation of the content item Iᵢ. Then, the second input sequence 221 may be processed using the second machine learning model 220 to obtain a second output sequence 222 of the second machine learning model. An output unit at a given position in the second output sequence 222 indicates a content item embedding representation predicted at the given position based on content item embedding representations before the given position in the second input sequence 221. Taking an output unit

$${E}_{5}^{′}$$

224 at a fourth position in the second output sequence 222 as an example,

$${E}_{4}^{′}$$

224 indicates a content item embedding representation predicted at the fourth position based on content item embedding representations (that is, E₁, E₂ and E₃) before the fourth position in the second input sequence 221.

After obtaining the second output sequence 222, the recommended content item for the target user may be determined based on the content item embedding representation indicated by the last output unit 223 in the second output sequence 222. The content item embedding representation indicated by the last output unit 223 may be predicted based on all the content item embedding representations included in the second input sequence.

In some embodiments, the recommended content item may be selected from a plurality of candidate content items based on a similarity between the content item embedding representation indicated by the last output unit 223 and content item embedding representations corresponding to the plurality of candidate content items. For example, the plurality of candidate content items may be sorted in descending order according to the similarity, and the candidate content item with the highest similarity is recommended to the target user as the recommended content item. In this way, generative recommendation can be realized, and customized recommended content can be provided according to different users' needs for content items, which can improve the user experience.

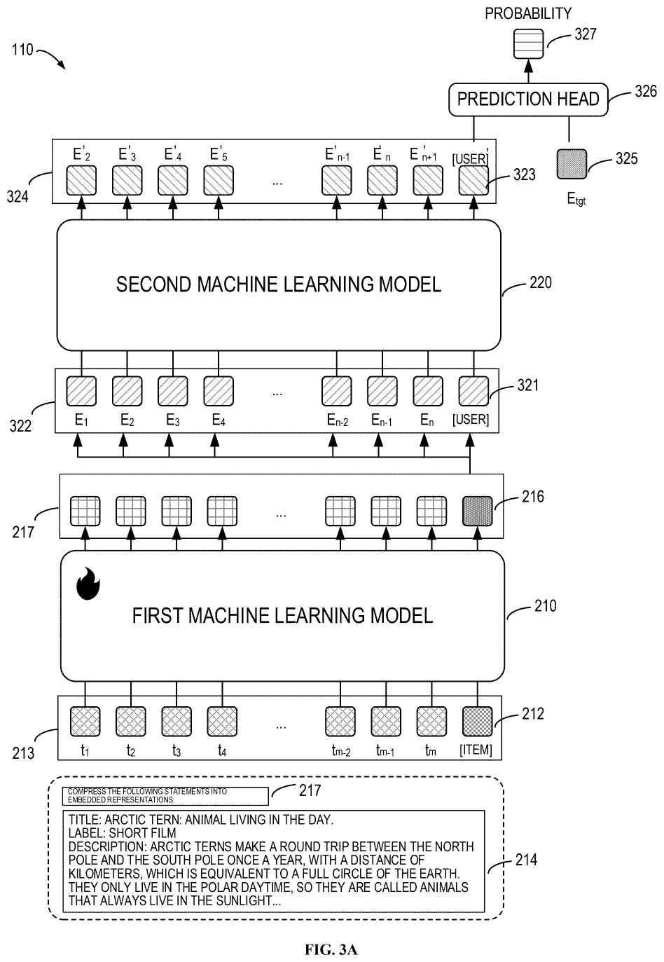

The embodiments of the present disclosure can implement not only the generative recommendation, but also the discriminative recommendation. The discriminative recommendation provided by some embodiments of the present disclosure will be described below with reference to FIG. 3A, and FIG. 3A shows a schematic diagram of an architecture of the recommendation system 110 according to other embodiments of the present disclosure. In the discriminative recommendation, the candidate content item may be given first, and then it is determined whether the candidate content item is to be recommended. As shown in FIG. 3, the architecture and processing related to the first machine learning model 210 may refer to the description of FIG. 2, which will not be repeated here. For the second machine learning model 220, a third input sequence 322 for the second machine learning model 220 may be generated based on a second prompt element 321 (represented by [USER]) and the plurality of content item embedding representations.

Generally, the second machine learning model 220 is used to predict a next word element based on a context. In order to enable the second machine learning model 220 to extract features of the target user, the second prompt element 321 may also be input into the second machine learning model 220, indicating that the second machine learning model 220 extracts a user embedding representation 323 for the target user from the plurality of content item embedding representations. Then, the third input sequence 322 may be processed using the second machine learning model 220 to obtain a third output sequence 324 of the second machine learning model 220, where the third output sequence 324 includes the user embedding representation 323.

After obtaining the user embedding representation 323, a probability of each of the at least one candidate content item being recommended to the target user is determined based on the user embedding representation 323 and content item embedding representations (for example, the content item embedding representation 325) of the at least one candidate content item. Taking the embedding representation of the candidate content item being the content item embedding representation 325 (represented by Etgt) as an example, the content item corresponding to the content item embedding representation 325 being recommended to the target user may be obtained by inputting the user embedding representation 323 and the content item embedding representation 325 into a prediction head 326. For example, the prediction head 326 may be a multilayer perception (abbreviated as MLP). Then, the recommended the content item 122 may be determined from the at least one candidate content item based on the probability. For example, a candidate content item with a probability greater than 50% may be determined as the recommended content item to be recommended to the target user.

In some embodiments, the second prompt element 321 is placed after the plurality of content item embedding representations in the third input sequence 322. In this way, placing the second prompt element at the end of the third input sequence enables the machine learning model to consider the entire input sequence, thereby extracting a more accurate embedding representation.

The following will describe another discriminative recommendation provided by some embodiments of the present disclosure with reference to FIG. 3B, and FIG. 3B shows a schematic diagram of an architecture of the recommendation system 110 according to other embodiments of the present disclosure. As shown in FIG. 3B, for each of the at least one candidate content item (for example, the content item corresponding to the content item embedding representation 325), a fourth input sequence 351 for the second machine learning model 220 may be generated based on the plurality of content item embedding representations and the content item embedding representation of the candidate content item. Then, the fourth input sequence 351 is processed using the second machine learning model 220 to obtain a fourth output sequence 352 of the second machine learning model 220.

After obtaining the fourth output sequence 352, the recommended content item may be determined from the at least one candidate content item based on the fourth output sequence 352 generated for the at least one content item. The fourth output sequence 352 may include a high-order cross feature 353 representing the candidate content item, and by inputting the cross feature 353 into the prediction head 326, the probability of the candidate content item being recommended may be obtained. For example, if the probability of the candidate content item is greater than 50%, the candidate content item is determined as the recommended content item.

In some embodiments, the prediction head 326 may be replaced with an online recommendation model. The structure of the online recommendation model is more complex, and it can output a more accurate probability, thereby the accuracy of determining the recommended content item is improved.

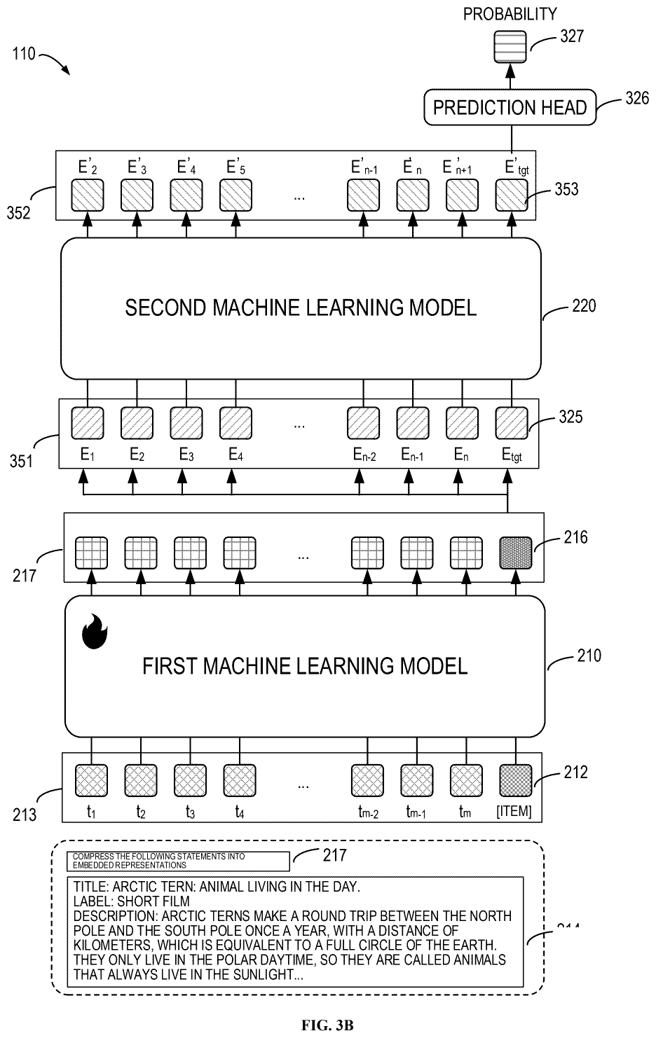

FIG. 4 shows a schematic diagram 400 of applying the first machine learning model 210 and the second machine learning model 220 to an online recommendation model according to some embodiments of the present disclosure. As shown in FIG. 4, if a content item is created in a content item creation stream 410, the trained first machine learning model 210 is used to generate a content item embedding representation of the content item. The generated content item embedding representation is saved to a content item storage 430. The content item storage 430 may store content item embedding representations of a series of content items that can be recommended.

For a target user to whom content is to be recommended, content item embedding representations corresponding to a series of content items for which the user has historically performed conversion behavior are obtained from the content item storage 430 based on historical behavior of the target user for use as inputs to the second machine learning model 220. In the embodiment described with reference to FIG. 3A, the trained second machine learning model 220 generates the user embedding representation based on the obtained content item embedding representations. In some embodiments, the user embedding representation of each user may be determined periodically, for example, the user embedding representation is determined according to a daily user stream 420 (for example, including content items for which the user performs conversion activities).

The generated user embedding representation is saved to the user storage 440. After receiving the online request 450, the online recommendation model 460 may obtain the corresponding user embedding representation from the user storage 440, obtain content item embeddings of the at least one candidate content item from the content item storage 430, and determine the content item to be recommended based on the user embedding representation and the content item embeddings.

It can be understood that FIG. 4 illustrates a possible application scenario of the machine learning models based on the embodiments of the present disclosure. In some embodiments, the content recommendation architecture described with reference to FIG. 2 may be directly deployed for online content recommendation. In some embodiments, the content recommendation architecture described with reference to FIG. 3B may be applied to invoke the second machine learning model 220 in real time to determine the probability between the target user to be recommended and each candidate machine learning model.

In some embodiments, the first machine learning model 210 and the second machine learning model 220 may be trained. For the generative recommendation (for example, the recommendation manner discussed with reference to FIG. 2), the first machine learning model 210 may be used to determine a plurality of sample content item embedding representations respectively corresponding to a plurality of sample content items based on a first sample prompt element and description information of each of the plurality of sample content items. The first sample prompt element indicates extraction of a corresponding sample content item embedding representation from the description information of each sample content item. Then, a first number of sample content item embedding representations are processed using the second machine learning model 220 to obtain a first sample output sequence of the second machine learning model. In an example, the first number is a relatively small number, for example, 150.

After obtaining the plurality of sample content item embedding representations and the sample output sequence, a first loss function may be determined based on the sample output unit at the given position (for example, the ith position) in the first sample output sequence and the sample content item embedding representation at the position (for example, the (i+1)th position) following the given position in the first number of sample content item embedding representations. In the training process, a contrastive learning loss (InfoCE loss) may be used as the training objective. For any sample output unit

$${E}_{i}^{′}$$

in the sample output sequence, a positive sample is Eᵢ₊₁ in the plurality of sample content item embedding representations, and a negative sample is another content item in the batch. The first loss function may be expressed as follows:

$${ℒ}_{gen} = - {\sum }_{j = 1}^{b} {\sum }_{i = 2}^{n} log \frac{{e}^{s ( {E}_{j , i}^{′} , {E}_{j , i} )}}{{e}^{s ( {E}_{j , i}^{′} , {E}_{j , i} )} + {\sum }_{k}^{N} {e}^{s ( {E}_{j , i}^{′} , {E}_{j , i , k} )}} \qquad ( 1 )$$

where s represents a similarity function having a learnable temperature parameter, E_{j,i} represents a content item embedding representation (which may also be referred to as a sample content item embedding representation) of the jth content item of the ith user,

$${E}_{j , i}^{′}$$

represents a content item embedding representation (which may also be referred to as a sample output unit) of the jth content item predicted for the ith user, N represents data of the negative sample, E_{j,i,k} represents a kth negative embedding representation of

$${E}_{j , i}^{′} ,$$

b represents a total number of users in the training batch, and n represents a length of the historical behavior data of the user. It should be understood that the foregoing provides an example of the loss function. In practical applications, various modifications of other loss functions may also be used.

After the first loss function is constructed, the first machine learning model 210 and the second machine learning model 220 are trained by reducing or minimizing the value of the first loss function.

In some embodiments, after the first machine learning model 210 and the second machine learning model 220 are trained at the same time, only the second machine learning model 220 may be trained. The trained first machine learning model 210 may be used to generate and store the content item embedding representation corresponding to the content item. In order to continue to train the second machine learning model 220, the required content item embedding representation may be obtained from the repository. In the case where the model parameters of the first machine learning model 210 remain unchanged, a second number of sample content item embedding representations may be processed using the second machine learning model 220 to obtain a second sample output sequence of the second machine learning model 220, where the second number is greater than the first number. For example, the first number is 150, and the second number is 1,000.

Then, the first loss function is determined based on the sample output unit at the given position in the second sample output sequence and the sample content item embedding representation at the position following the given position in the second number of sample content item embedding representations. After the first loss function is determined, the second machine learning model 220 is trained by reducing or minimizing the value of the first loss function. The first loss function may be a loss function as shown in formula (1). In some embodiments, the first machine learning model 210 and the second machine learning model 220 may be jointly trained. For the discriminative recommendation (for example, the recommendation manner discussed with reference to FIG. 3), the first machine learning model 210 is used to determine a plurality of sample content item embedding representations respectively corresponding to a plurality of sample content items based on a first sample prompt element and description information of each of the plurality of sample content items. The first sample prompt element indicates extraction of a corresponding sample content item embedding representation from the description information of each sample content item. Then, a first number of sample content item embedding representations are processed using the second machine learning model 220 to obtain a first sample user embedding representation for a first sample user. Based on the model architecture shown in FIG. 3A, the input of the second machine learning model 220 during training also includes a second sample prompt element, and the second sample prompt element indicates extraction of the first sample user embedding representation for the first sample user from the plurality of sample content item embedding representations. A first probability of a first sample candidate content item being recommended to the first sample user may be determined according to the first sample user embedding representation and content item embedding representations of the first sample candidate content item.

After the first probability of the first sample candidate content item being recommended to the first sample user is determined, a second loss function may be determined based on a difference between a label of the first sample candidate content item and the first probability. A binary cross-entropy loss function may be used as the second loss function, and the second loss function may be expressed as follows:

$${ℒ}_{cls} = - ( y \cdot log ( x ) + ( 1 - y ) \cdot log ( 1 - x ) ) \qquad ( 2 )$$

where y represents a label of the training sample (which may also be referred to as a label of the sample candidate content item), and x represents a probability predicted by the second machine learning model 220.

After the second loss function is constructed, the first machine learning model 210 and the second machine learning model 220 are trained by at least reducing or minimizing the value of the second loss function.

In some embodiments, for the discriminative recommendation, the first loss function and the second loss function may be combined to obtain a third loss function to train the first machine learning model 210 and the second machine learning model 220. The prediction of the next content item may be used as an auxiliary loss. In an example, the first loss function and the second loss function may be weighted to obtain the third loss function. The third loss function may be expressed as follows:

$${ℒ}_{dis} = {λℒ}_{gen} + {ℒ}_{cls} \qquad ( 3 )$$

where λ controls the weight of the auxiliary loss.

In some embodiments, after the first machine learning model 210 and the second machine learning model 220 are trained at the same time, only the second machine learning model 220 may be trained. The trained first machine learning model 210 may be used to generate and store the content item embedding representation corresponding to the content item. In order to continue to train the second machine learning model 220, the required content item embedding representation may be obtained from the repository. In the case where the model parameters of the first machine learning model 210 remain unchanged, a second number of sample content item embedding representations may be processed using the second machine learning model 220 to obtain a second sample user embedding representation for a second sample user, where the second number is greater than the first number. For example, the first number is 150, and the second number is 1,000. Then, a probability of a second sample candidate content item being recommended to the second sample user may be determined according to the second sample user embedding representation and content item embedding representations of the second sample candidate content item.

Then, the second loss function may be determined based on a difference between a label of the second sample candidate content item and the second probability. The second machine learning model 220 is trained by at least reducing or minimizing the value of the second loss function. The second loss function may be a loss function as shown in formula (2).

In some embodiments, the second machine learning model 220 may also be trained using the loss function as shown in formula (3).

In some embodiments, the embedding representations of the first prompt element 212 and the second prompt element 321 are learnable. The embedding representation of the first prompt element and/or the embedding representation of the second prompt element are determined during the training process of the first machine learning model 210 and the second machine learning model 220 for model inference. In this way, by updating the embedding representation of the first prompt element and/or the embedding representation of the second prompt element, the semantic information of the first prompt element and/or the second prompt element may be better captured, thereby the accuracy of recommendation is improved.

The above describes the content recommendation solution by using the hierarchical machine learning model (e.g., the language model) proposed by the embodiments of the present disclosure. It is proved in some experiments that fine-tuning the hierarchical machine learning model for the recommendation target is effective, and fine-tuning may improve the performance of the hierarchical machine learning model. The scalability of the hierarchical machine learning model is proved in some experiments, and the performance of recommendation may be effectively improved as the number of parameters in the machine learning model increases. It is proved in some experiments that the performance of the hierarchical machine learning model proposed by the embodiments of the present disclosure is better than the traditional ID-based recommendation model. It is proved in some experiments that the computational complexity is effectively reduced.

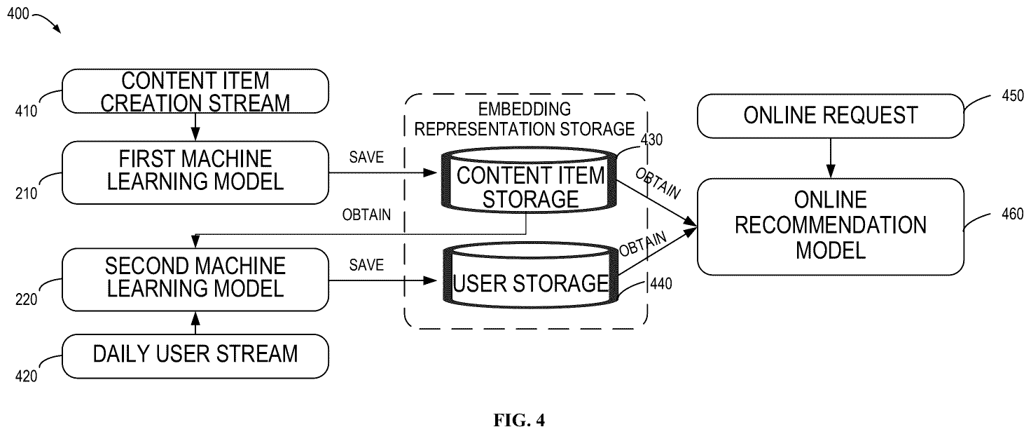

FIG. 5 shows a flowchart of a method 500 for content recommendation according to some embodiments of the present disclosure. The method 500 may be implemented at the recommendation system 110 in FIG. 1. The method 500 will be described with reference to the environment 100 in FIG. 1.

At block 510, the recommendation system 110 obtains a content item sequence associated with historical behavior data of a target user, the content item sequence comprising a plurality of content items for which the target user sequentially performs conversion behavior.

At block 520, the recommendation system 110 determines, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item.

At block 530, the recommendation system 110 determines, by using a second machine learning model and based on at least the plurality of content item embedding representations, a recommended content item to be recommended to the target user.

In some embodiments, determining the plurality of content item embedding representations respectively corresponding to the plurality of content items includes: for each of the plurality of content items, generating, based on the first prompt element and the description information of the content item, a first input sequence for the first machine learning model; and obtaining, by using the first machine learning model to process the first input sequence, a first output sequence of the first machine learning model, the first output sequence comprising a content item embedding representation.

In some embodiments, the first prompt element is placed after the description information of the content item in the first input sequence.

In some embodiments, determining, by using the second machine learning model and based on at least the plurality of content item embedding representations, the recommended content item to be recommended to the target user includes: generating, based on the plurality of content item embedding representations, a second input sequence for the second machine learning model; obtaining, by using the second machine learning model to process the second input sequence, a second output sequence of the second machine learning model, an output unit at a given position in the second output sequence indicating a content item embedding representation predicted at the given position based on a content item embedding representation before the given position in the second input sequence; and determining the recommended content item based on a content item embedding representation indicated by a last output unit in the second output sequence.

In some embodiments, determining the recommended content item based on the content item embedding representation indicated by the last output unit in the second output sequence includes: selecting, based on a similarity between the content item embedding representation indicated by the last output unit and content item embedding representations corresponding to the plurality of candidate content items, the recommended content item from a plurality of candidate content items.

In some embodiments, determining, by using the second machine learning model and based on at least the plurality of content item embedding representations, the recommended content item to be recommended to the target user includes: generating, based on a second prompt element and the plurality of content item embedding representations, a third input sequence for the second machine learning model, the second prompt element indicating extraction of a user embedding representation for the target user from the plurality of content item embedding representations; obtaining, by using the third machine learning model to process the third input sequence, a third output sequence of the third machine learning model, the third output sequence comprising the user embedding representation; determining, based on the user embedding representation and content item embedding representations of at least one candidate content item, a probability of each of the at least one candidate content item being recommended to the target user; and determining, based on the probability, the recommended content item from the at least one candidate content item.

In some embodiments, the second prompt element is placed after the plurality of content item embedding representations in the third input sequence.

In some embodiments, determining, by using the second machine learning model and based on at least the plurality of content item embedding representations, the recommended content item to be recommended to the target user includes: generating, for each candidate content item of at least one candidate content item and based on the plurality of content item embedding representations and a content item embedding representation of the candidate content item, a fourth input sequence for the second machine learning model; obtaining, by using the second machine learning model to process the fourth input sequence, a fourth output sequence of the second machine learning model; and determining, based on the fourth output sequence generated for the at least one candidate content item, the recommended content item from the at least one candidate content item.

In some embodiments, the first machine learning model and the second machine learning model are language models.

In some embodiments, the first machine learning model and the second machine learning model are trained by: determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; obtaining, by using the second machine learning model to process a first number of sample content item embedding representations, a first sample output sequence of the second machine learning model; determining a first loss function based on a sample output unit at a given position in the first sample output sequence and a sample content item embedding representation at a position after the given position in the first number of sample content item embedding representations; and training the first machine learning model and the second machine learning model by reducing or minimizing a value of the first loss function.

In some embodiments, when the model parameters of the first machine learning model remain unchanged, the second machine learning model is further trained by: obtaining, by using the second machine learning model to process a second number of sample content item embedding representations, a second sample output sequence of the second machine learning model, the second number is greater than the first number; determining the first loss function based on the sample output unit at the given position in the second sample output sequence and the sample content item embedding representation at the position following the given position in the second number of sample content item embedding representations; and training the second machine learning model by reducing or minimizing a value of the first loss function.

In some embodiments, the first machine learning model and the second machine learning model are trained by: determining, by using the first machine learning model and based on a first sample prompt element and description information of each of the plurality of sample content items, a plurality of sample content item embedding representations respectively corresponding to a plurality of sample content items, the first sample prompt element indicating extraction of a corresponding sample content item embedding representation from the description information of each sample content item; obtaining, by using the second machine learning model to process a first number of sample content item embedding representations, a first sample user embedding representation for a first sample user; determining, according to the first sample user embedding representation and a content item embedding representation of the first sample candidate content item, a first probability of a first sample candidate content item being recommended to the first sample user; determining a second loss function based on a difference between a label of the first sample candidate content item and the first probability; and training the first machine learning model and the second machine learning model by at least reducing or minimizing a value of the second loss function.

In some embodiments, when the model parameters of the first machine learning model remain unchanged, the second machine learning model is further trained by: obtaining, by using the second machine learning model to process a second number of sample content item embedding representations, a second sample user embedding representation for a second sample user, wherein the second number is greater than the first number; determining, according to the second sample user embedding representation and a content item embedding representation of the second sample candidate content item, a probability of a second sample candidate content item being recommended to the second sample user; determining a second loss function based on a difference between a label of the second sample candidate content item and the second probability; and training the second machine learning model by at least reducing or minimizing a value of the second loss function.

In some embodiments, the embedding representation of the first prompt element and/or the embedding representation of the second prompt element are determined during the training process of the first machine learning model and the second machine learning model.

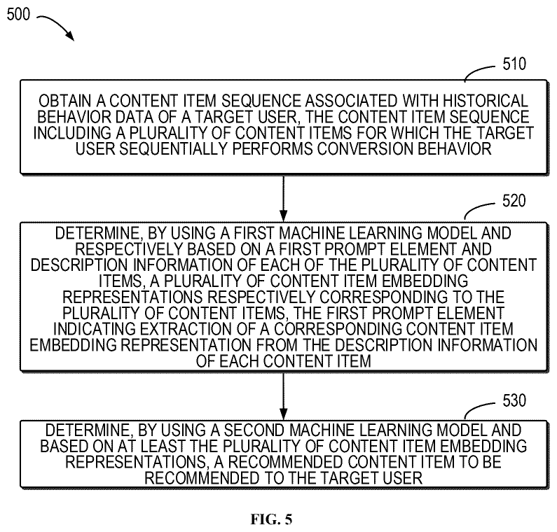

The embodiments of the present disclosure further provide corresponding apparatuses for implementing the above methods or processes. FIG. 6 shows an example structural block diagram of an apparatus 600 for content recommendation according to some embodiments of the present disclosure. The apparatus 600 may be implemented or included in the recommendation system 110. Various modules/components in the apparatus 600 may be implemented by hardware, software, firmware, or any combination thereof.

As shown in FIG. 6, the apparatus 600 includes a content item sequence obtaining module 610 configured to obtain a content item sequence associated with historical behavior data of a target user, the content item sequence comprising a plurality of content items for which the target user sequentially performs conversion behavior. The apparatus 600 further includes a content item embedding representation determining module 620 configured to determine, by using a first machine learning model and based on a first prompt element and description information of each of the plurality of content items respectively, a plurality of content item embedding representations respectively corresponding to the plurality of content items, the first prompt element indicating extraction of a corresponding content item embedding representation from the description information of each content item. The apparatus 600 further includes a recommended content item determining module 630 configured to determine, by using a second machine learning model and based on at least the plurality of content item embedding representations, a recommended content item to be recommended to the target user.

In some embodiments, the content item embedding representation determining module 620 is further configured to, for each content item of the plurality of content items, generate, based on the first prompt element and the description information of the content item, a first input sequence for the first machine learning model; and obtain, by using the first machine learning model to process the first input sequence, a first output sequence of the first machine learning model, the first output sequence comprising a content item embedding representation.

In some embodiments, the first prompt element is placed after the description information of the content item in the first input sequence.

In some embodiments, the recommended content item determining module 630 is further configured to generate, based on the plurality of content item embedding representations, a second input sequence for the second machine learning model; obtain, by using the second machine learning model to process the second input sequence, a second output sequence of the second machine learning model, an output unit at a given position in the second output sequence indicating a content item embedding representation predicted at the given position based on a content item embedding representation before the given position in the second input sequence; and determine the recommended content item based on a content item embedding representation indicated by a last output unit in the second output sequence.

In some embodiments, the recommended content item determining module 630 is further configured to select, based on a similarity between the content item embedding representation indicated by the last output unit and content item embedding representations corresponding to the plurality of candidate content items, the recommended content item from a plurality of candidate content items.

In some embodiments, the recommended content item determining module 630 is further configured to generate, based on a second prompt element and the plurality of content item embedding representations, a third input sequence for the second machine learning model, the second prompt element indicating extraction of a user embedding representation for the target user from the plurality of content item embedding representations; obtain, by using the third machine learning model to process the third input sequence, a third output sequence of the third machine learning model, the third output sequence comprising the user embedding representation; determine, based on the user embedding representation and content item embedding representations of at least one candidate content item, a probability of each of the at least one candidate content item being recommended to the target user; and determine, based on the probability, the recommended content item from the at least one candidate content item.

In some embodiments, the second prompt element is placed after the plurality of content item embedding representations in the third input sequence.

In some embodiments, the recommended content item determining module 630 is further configured to generate, for each candidate content item of at least one candidate content item and based on the plurality of content item embedding representations and a content item embedding representation of the candidate content item, a fourth input sequence for the second machine learning model; obtain, by using the second machine learning model to process the fourth input sequence, a fourth output sequence of the second machine learning model; and determine, based on the fourth output sequence generated for the at least one candidate content item, the recommended content item from the at least one candidate content item.

In some embodiments, the first machine learning model and the second machine learning model are language models.

In some embodiments, the first machine learning model and the second machine learning model are trained by: determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; obtaining, by using the second machine learning model to process a first number of sample content item embedding representations, a first sample output sequence of the second machine learning model; determining a first loss function based on a sample output unit at a given position in the first sample output sequence and a sample content item embedding representation at a position after the given position in the first number of sample content item embedding representations; and training the first machine learning model and the second machine learning model by reducing or minimizing a value of the first loss function.

In some embodiments, when the model parameters of the first machine learning model remain unchanged, the second machine learning model is further trained by: obtaining, by using the second machine learning model to process a second number of sample content item embedding representations, a second sample output sequence of the second machine learning model, the second number is greater than the first number; determining the first loss function based on the sample output unit at the given position in the second sample output sequence and the sample content item embedding representation at the position following the given position in the second number of sample content item embedding representations; and training the second machine learning model by reducing or minimizing a value of the first loss function.

In some embodiments, the first machine learning model and the second machine learning model are trained by: determining, by using the first machine learning model and based on a first sample prompt element and description information of each of the plurality of sample content items, a plurality of sample content item embedding representations respectively corresponding to a plurality of sample content items, the first sample prompt element indicating extraction of a corresponding sample content item embedding representation from the description information of each sample content item; obtaining, by using the second machine learning model to process a first number of sample content item embedding representations, a first sample user embedding representation for a first sample user; determining, according to the first sample user embedding representation and a content item embedding representation of the first sample candidate content item, a first probability of a first sample candidate content item being recommended to the first sample user; determining a second loss function based on a difference between a label of the first sample candidate content item and the first probability; and training the first machine learning model and the second machine learning model by at least reducing or minimizing a value of the second loss function.

In some embodiments, when the model parameters of the first machine learning model remain unchanged, the second machine learning model is further trained by: obtaining, by using the second machine learning model to process a second number of sample content item embedding representations, a second sample user embedding representation for a second sample user, wherein the second number is greater than the first number; determining, according to the second sample user embedding representation and a content item embedding representation of the second sample candidate content item, a probability of a second sample candidate content item being recommended to the second sample user; determining a second loss function based on a difference between a label of the second sample candidate content item and the second probability; and training the second machine learning model by at least reducing or minimizing a value of the second loss function.

In some embodiments, the embedding representation of the first prompt element and/or the embedding representation of the second prompt element are determined during the training process of the first machine learning model and the second machine learning model.

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to the machine-executable instructions, some or all of the units and/or modules in the apparatus 600 may be implemented at least in part by one or more hardware logic components. As an example and not a limitation, example types of hardware logic components that may be used include a field programmable gate array (FPGA), an application specific integrated circuit (ASIC), an application specific standard product (ASSP), a system on chip (SOC), a complex programmable logic device (CPLD), and so on.

It should be understood that one or more steps in the above methods may be performed by an appropriate electronic device or a combination of electronic devices. Such an electronic device or a combination of electronic devices may include, for example, the recommendation system 110 in FIG. 1.

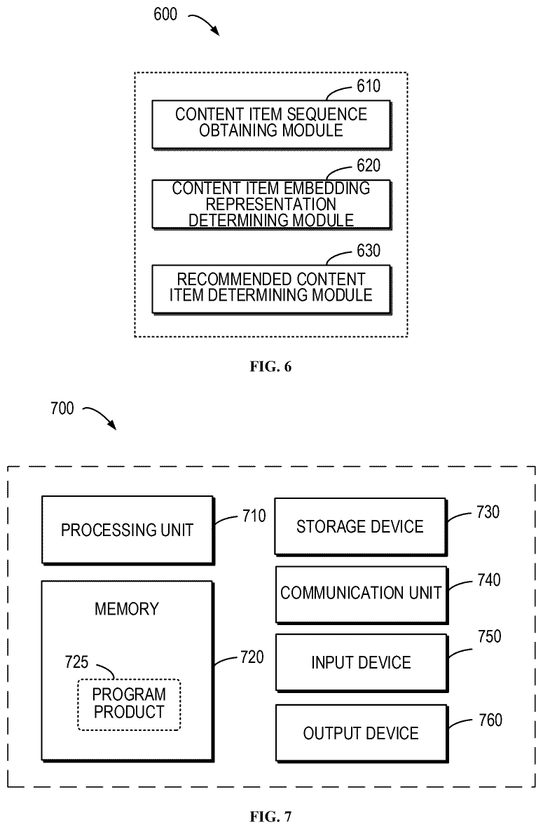

FIG. 7 shows a block diagram of an electronic device 700 in which one or more embodiments of the present disclosure may be implemented. It should be understood that the electronic device 700 shown in FIG. 7 is only illustrative, and should not constitute any limitation to the function and scope of the embodiments described herein. The electronic device 700 shown in FIG. 7 may be used to implement the recommendation system 110 in FIG. 1 or the apparatus 600 in FIG. 6.

As shown in FIG. 7, the electronic device 700 is in the form of a general-purpose electronic device. The components of the electronic device 700 may include, but are not limited to, one or more processors or processing units 710, a memory 720, a storage device 730, one or more communication units 740, one or more input devices 750, and one or more output devices 760. The processing unit 710 may be a physical or virtual processor and can perform various processing according to programs stored in the memory 720. In a multi-processor system, multiple processing units execute computer-executable instructions in parallel to improve the parallel processing ability of the electronic device 700.

The electronic device 700 typically includes a plurality of computer storage media. Such media may be any available media accessible by the electronic device 700, including but not limited to volatile and non-volatile media, and removable and non-removable media. Memory 720 may be volatile memory (such as registers, cache, random access memory (RAM)), non-volatile memory (such as read-only memory (ROM), electrically erasable programmable read-only memory (EEPROM), flash memory), or some combination thereof. The storage device 730 may be a removable or non-removable medium, and may include a machine-readable medium, such as a flash drive, a magnetic disk, or any other medium, which may be capable of storing information and/or data and may be accessible within the electronic device 700.

The electronic device 700 may further include additional removable/non-removable, volatile/non-volatile storage media. Although not shown in FIG. 7, a disk drive for reading from or writing to a removable, non-volatile magnetic disk (such as a “floppy disk”) and an optical disk drive for reading from or writing to a removable, non-volatile optical disk may be provided. In these cases, each drive may be connected to a bus (not shown) by one or more data media interfaces. The memory 720 may include a computer program product 725, which has one or more program modules configured to perform various methods or actions of various embodiments of the present disclosure.

The communication unit 740 implements communication with other electronic devices through a communication medium. Additionally, the functions of the components of the electronic device 700 may be implemented in a single computing cluster or multiple computing machines that can communicate through communication connections. Therefore, the electronic device 700 may operate in a networked environment using logical connections to one or more other servers, network personal computers (PCs), or another network node.

The input device 750 may be one or more input devices such as a mouse, a keyboard, a trackball, etc. The output device 760 may be one or more output devices such as a display, a speaker, a printer, etc. The electronic device 700 may also communicate with one or more external devices (not shown) such as a storage device, a display device, etc. through the communication unit 740 as required, communicate with one or more devices that enable the user to interact with the electronic device 700, or communicate with any device (such as a network card, a modem, etc.) that enables the electronic device 700 to communicate with one or more other electronic devices. Such communication may be performed via an input/output (I/O) interface (not shown).

According to an example implementation of the present disclosure, a computer-readable storage medium is provided, on which computer-executable instructions are stored, where the computer-executable instructions are executed by a processor to implement the above-described method. According to an example implementation of the present disclosure, a computer program product is further provided, which is tangibly stored on a non-transitory computer-readable medium and includes computer-executable instructions, and the computer-executable instructions are executed by a processor to implement the above-described method.

Various aspects of the present disclosure are described herein with reference to flowcharts and/or block diagrams of methods, apparatuses, devices, and computer program products implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer, or other programmable data processing apparatus to produce a machine, such that the instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium, and these instructions cause a computer, a programmable data processing apparatus, and/or other devices to operate in a specific manner, such that the computer-readable medium storing the instructions includes an article of manufacture including instructions for implementing various aspects of the functions/acts specified in one or more blocks of the flowcharts and/or block diagrams.

The computer-readable program instructions may be loaded onto a computer, other programmable data processing apparatus, or other device to cause a series of operational steps to be performed on the computer, other programmable data processing apparatus, or other device to produce a computer-implemented process, such that the instructions executed on the computer, other programmable data processing apparatus, or other device implement the functions/acts specified in one or more blocks of the flowcharts and/or block diagrams.

The flowcharts and block diagrams in the drawings illustrate the architecture, functionality, and operation of possible implementations of systems, methods, and computer program products according to multiple implementations of the present disclosure. In this regard, each block in the flowcharts or block diagrams may represent a module, program segment, or portion of instructions, and the module, program segment, or portion of instructions contains one or more executable instructions for implementing specified logical functions. In some alternative implementations, the functions noted in the blocks may also occur out of the order noted in the figures. For example, two blocks shown in succession may, in fact, be executed substantially concurrently, or the blocks may sometimes be executed in a reverse order, depending upon the functionality involved. It is also noted that each block of the block diagrams and/or flowcharts and combinations of blocks in the block diagrams and/or flowcharts may be implemented by a dedicated hardware-based system that performs the specified functions or acts, or may also be implemented by a combination of dedicated hardware and computer instructions.

Various implementations of the present disclosure have been described above. The above description is illustrative, not exhaustive, and is not limited to the disclosed implementations. Many modifications and variations will be apparent to those of ordinary skill in the art without departing from the scope and spirit of the described implementations. The terminology used herein was chosen in order to best explain the principles of the implementations, the practical application, or the improvement of technology in the market, or to enable others of ordinary skill in the art to understand the implementations disclosed herein.

1. A method for content recommendation, comprising:
obtaining a content item sequence associated with historical behavior data of a target user, the content item sequence comprising a plurality of content items for which the target user sequentially performs conversion behavior;
determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; and
determining, by using a second machine learning model and based on at least the plurality of content item embedding representations, a recommended content item to be recommended to the target user.

2. The method of claim 1, wherein determining the plurality of content item embedding representations respectively corresponding to the plurality of content items comprises: for each content item of the plurality of content items,
generating, based on the first prompt element and the description information of the content item, a first input sequence for the first machine learning model; and
obtaining, by using the first machine learning model to process the first input sequence, a first output sequence of the first machine learning model, the first output sequence comprising a content item embedding representation.

3. The method of claim 2, wherein the first prompt element is placed after the description information of the content item in the first input sequence.

4. The method of claim 1, wherein determining, by using the second machine learning model and based on at least the plurality of content item embedding representations, the recommended content item to be recommended to the target user comprises:
generating, based on the plurality of content item embedding representations, a second input sequence for the second machine learning model;
obtaining, by using the second machine learning model to process the second input sequence, a second output sequence of the second machine learning model, an output unit at a given position in the second output sequence indicating a content item embedding representation predicted at the given position based on a content item embedding representation before the given position in the second input sequence; and
determining the recommended content item based on a content item embedding representation indicated by a last output unit in the second output sequence.

5. The method of claim 4, wherein determining the recommended content item based on the content item embedding representation indicated by the last output unit in the second output sequence comprises:
selecting, based on a similarity between the content item embedding representation indicated by the last output unit and content item embedding representations corresponding to the plurality of candidate content items, the recommended content item from a plurality of candidate content items.

6. The method of claim 1, wherein determining, by using the second machine learning model and based on at least the plurality of content item embedding representations, the recommended content item to be recommended to the target user comprises:
generating, based on a second prompt element and the plurality of content item embedding representations, a third input sequence for the second machine learning model, the second prompt element indicating extraction of a user embedding representation for the target user from the plurality of content item embedding representations;
obtaining, by using the third machine learning model to process the third input sequence, a third output sequence of the third machine learning model, the third output sequence comprising the user embedding representation;
determining, based on the user embedding representation and content item embedding representations of at least one candidate content item, a probability of each of the at least one candidate content item being recommended to the target user; and
determining, based on the probability, the recommended content item from the at least one candidate content item.

7. The method of claim 6, wherein the second prompt element is placed after the plurality of content item embedding representations in the third input sequence.

8. The method of claim 1, wherein determining, by using the second machine learning model and based on at least the plurality of content item embedding representations, the recommended content item to be recommended to the target user comprises:
generating, for each candidate content item of at least one candidate content item and based on the plurality of content item embedding representations and a content item embedding representation of the candidate content item, a fourth input sequence for the second machine learning model;
obtaining, by using the second machine learning model to process the fourth input sequence, a fourth output sequence of the second machine learning model; and
determining, based on the fourth output sequence generated for the at least one candidate content item, the recommended content item from the at least one candidate content item.

9. The method of claim 1, wherein the first machine learning model and the second machine learning model are language models.

10. The method of claim 1, wherein the first machine learning model and the second machine learning model are trained by:
determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item;
obtaining, by using the second machine learning model to process a first number of sample content item embedding representations, a first sample output sequence of the second machine learning model;
determining a first loss function based on a sample output unit at a given position in the first sample output sequence and a sample content item embedding representation at a position after the given position in the first number of sample content item embedding representations; and
training the first machine learning model and the second machine learning model by reducing or minimizing a value of the first loss function.

11. The method of claim 10, wherein when the model parameters of the first machine learning model remain unchanged, the second machine learning model is further trained by:
obtaining, by using the second machine learning model to process a second number of sample content item embedding representations, a second sample output sequence of the second machine learning model, the second number is greater than the first number;
determining the first loss function based on the sample output unit at the given position in the second sample output sequence and the sample content item embedding representation at the position following the given position in the second number of sample content item embedding representations; and
training the second machine learning model by reducing or minimizing a value of the first loss function.

12. The method of claim 1, wherein the first machine learning model and the second machine learning model are trained by:
determining, by using the first machine learning model and based on a first sample prompt element and description information of each of the plurality of sample content items, a plurality of sample content item embedding representations respectively corresponding to a plurality of sample content items, the first sample prompt element indicating extraction of a corresponding sample content item embedding representation from the description information of each sample content item;
obtaining, by using the second machine learning model to process a first number of sample content item embedding representations, a first sample user embedding representation for a first sample user;
determining, according to the first sample user embedding representation and a content item embedding representation of the first sample candidate content item, a first probability of a first sample candidate content item being recommended to the first sample user;
determining a second loss function based on a difference between a label of the first sample candidate content item and the first probability; and
training the first machine learning model and the second machine learning model by at least reducing or minimizing a value of the second loss function.

13. The method of claim 12, wherein when the model parameters of the first machine learning model remain unchanged, the second machine learning model is further trained by:
obtaining, by using the second machine learning model to process a second number of sample content item embedding representations, a second sample user embedding representation for a second sample user, wherein the second number is greater than the first number;
determining, according to the second sample user embedding representation and a content item embedding representation of the second sample candidate content item, a probability of a second sample candidate content item being recommended to the second sample user;
determining the second loss function based on a difference between a label of the second sample candidate content item and the second probability; and
training the second machine learning model by at least reducing or minimizing a value of the second loss function.

14. The method of claim 10, wherein an embedding representation of the first prompt element and/or an embedding representation of the second prompt element are determined during a training process of the first machine learning model and the second machine learning model.

15. An electronic device, comprising:
at least one processor; and
at least one memory, wherein the at least one memory is coupled to the at least one processor and stores instructions for execution by the at least one processor, and the instructions, when executed by the at least one processor, cause the device to perform acts comprising:
obtaining a content item sequence associated with historical behavior data of a target user, the content item sequence comprising a plurality of content items for which the target user sequentially performs conversion behavior;
determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; and
determining, by using a second machine learning model and based on at least the plurality of content item embedding representations, a recommended content item to be recommended to the target user.

16. The electronic device of claim 15, wherein determining the plurality of content item embedding representations respectively corresponding to the plurality of content items comprises: for each content item of the plurality of content items,
generating, based on the first prompt element and the description information of the content item, a first input sequence for the first machine learning model; and
obtaining, by using the first machine learning model to process the first input sequence, a first output sequence of the first machine learning model, the first output sequence comprising a content item embedding representation.

17. The electronic device of claim 16, wherein the first prompt element is placed after the description information of the content item in the first input sequence.

18. The electronic device of claim 15, wherein determining, by using the second machine learning model and based on at least the plurality of content item embedding representations, the recommended content item to be recommended to the target user comprises:
generating, based on the plurality of content item embedding representations, a second input sequence for the second machine learning model;
obtaining, by using the second machine learning model to process the second input sequence, a second output sequence of the second machine learning model, an output unit at a given position in the second output sequence indicating a content item embedding representation predicted at the given position based on a content item embedding representation before the given position in the second input sequence; and
determining the recommended content item based on a content item embedding representation indicated by a last output unit in the second output sequence.

19. The electronic device of claim 18, wherein determining the recommended content item based on the content item embedding representation indicated by the last output unit in the second output sequence comprises:
selecting, based on a similarity between the content item embedding representation indicated by the last output unit and content item embedding representations corresponding to the plurality of candidate content items, the recommended content item from a plurality of candidate content items.

20. A non-transitory computer-readable storage medium having a computer program stored thereon, the computer program, when executed by a processor, implementing acts comprising:
obtaining a content item sequence associated with historical behavior data of a target user, the content item sequence comprising a plurality of content items for which the target user sequentially performs conversion behavior;
determining, by using a first machine learning model and respectively based on a first prompt element and description information of each of the plurality of content items, a plurality of content item embedding representations respectively corresponding to the plurality of content items, the first prompt element indicating extraction of a corresponding content item embedding representation from the description information of each content item; and
determining, by using a second machine learning model and based on at least the plurality of content item embedding representations, a recommended content item to be recommended to the target user.
